(19) United States
(12) Patent Application Publication
(10) Pub. No.: US 2012/0008456 A1
(43) Pub. Date: Jan. 12, 2012

(54) INTENSE GLASS BATCH MIXER

(76) Inventors: VALENTIN D. TOKAREV, SALAVAT (RU); Sergej A. Agureev, Ishimbaj (RU); Radik I. Sultanov, Ufa (RU); Vladimir I. Litvin, Salavat (RU); Petr A. Fomin, Salavat (RU); Oleg N. Popov, Moscow (RU)

(21) Appl. No.: 13/100,864

(22) Filed: May 4, 2011

(30) Foreign Application Priority Data
May 4, 2010 (RU) RU 2010117809/03

(51) Int. Cl. B01F 15/02; B01F 15/00; B01F 7/02

(52) U.S. Cl. 366/189

(57) ABSTRACT

A continuous-action intense glass batch mixer comprising a horizontal cylindrical mixing chamber with an inlet fitting for loading batch and scrap glass, a water nozzle, and a steam nozzle. A chamber has loading, accumulation and unloading zones and a rotor central shaft. The mixer has a hole for unloading the mixture of batch and scrap glass, with magnetic separators installed under it, wherein in order to clean the chamber walls, scrapers are installed on the rotor shaft, and mixing cutting tools are installed on the shaft in the loading and unloading zones and uniformly distributed around the circumference at a 90° angle to the shaft, except that the second cutting tool is installed at a 60° angle to the first cutting tool (the intensive stirring zone). The total width of the work surface of the cutting tools is 15-30% larger than the length of the zone they are installed in.

### CROSS-REFERENCE TO RELATED APPLICATION

This application claims the benefit of the priority filing date of Russian application no. RU 2010117809/03 filed on May 4, 2010 in the name of OAO Salavatsteklo.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention relates to the glass industry, namely to devices for preparing a high-quality glass batch (hereinafter “batch”) immediately before loading it into a glass furnace.

Known is a high-speed mixer for producing raw materials for foam silicate gravel, namely, a horizontal cylindrical apparatus with a central shaft having blades that rotate inside a housing, wherein the blades prevent material from sticking to the inside of the housing (RU 2307097, published 2007).

The housing moves with respect to the shaft, which allows the rotating blades to periodically shave off wet batch material stuck to the housing's inside surface.

The closest to the proposed mixer in technical essence and achieved results is a continuous-action glass batch mixer comprising a horizontal cylindrical mixing chamber with an inlet fitting for loading batch and scrap glass, a discharge hole for unloading the batch and scrap glass, a horizontal pipe with a set of cone-shaped nozzles for feeding water, buckets and movable blades installed on the inside surface of the chamber, and a set of buckets, wherein scrapers are installed on the chamber's end walls (GB 1001005, published 1965).

Known mixers have insufficient batch homogeneity. It is also impossible to achieve an optimum moisture content of batch due to its unavoidable clumping and sticking on the inside surface of the housing, which slows down the glassmaking process and increases fuel consumption when operating a glass furnace.

The technical result of the claimed invention is improved glass quality and reduced power consumption for glass melting (attributable to the increased homogeneity of the mixture of a batch and scrap glass) while ensuring optimum moisture content and temperature, which speeds the glass making process and provides a highly homogeneous glass mass. The proposed mixer also makes it possible to reduce dusting and carryover of the volatile components of the batch to regenerators. This reduces the wear on the refractory material of a furnace's superstructure and regenerator brickwork, increasing the life of a glass furnace.

Said technical result is achieved due to the design features of the claimed continuous-action intense glass batch mixer. The mixer is a horizontal cylindrical mixing chamber with a central rotor and an electric drive. The mixing chamber has an inlet fitting (15) for loading batch and scrap glass, and a discharge hole (16) for the mixture of the batch and scrap glass, with magnetic separators located under it. Lengthwise, the chamber has a loading zone (12), an accumulation zone (13) and an unloading zone (14); the loading zone has a water nozzle (18) and a steam nozzle (19) for batch wetting. The rotor central shaft (9) is installed along the chamber axis. Mixing cutting tools (10) are installed In the loading and unloading zones on the shaft and are uniformly distributed around the circumference of the shaft at a 90° angle to the shaft, except that the second cutting tool is installed at a 60° angle to the first cutting tool, wherein the total surface of the cutting tools is 15-30% larger than the length of the zone they are installed in. On the chamber end walls, scrapers (11) are installed which prevent the mixture from sticking.

### DRAWINGS

FIG. 1 shows the process of preparation of batch and scrap glass.

FIG. 2 shows the intense glass batch mixer (vertical section).

FIG. 3 shows sections A-A and B-B of the mixer.

### SUMMARY

The invention relates to a device for preparing high-quality glass batch immediately before loading into a glass furnace by speeding the glass making process, resulting in improved glass quality and reduced power consumption for melting glass. A continuous-action intense glass batch mixer comprises a horizontal cylindrical mixing chamber with an inlet fitting for loading batch and scrap glass, a water nozzle and a steam nozzle. A chamber has loading, accumulation and unloading zones and a rotor central shaft installed in the chamber. The mixer has a hole for unloading the mixture of batch and scrap glass, with magnetic separators installed under it, wherein in order to clean the chamber walls, scrapers are installed on the rotor shaft, and mixing cutting tools are installed on the shaft in the loading and unloading zones and uniformly distributed around the circumference of the shaft at a 90° angle to the shaft, except that the second cutting tool is installed at a 60° angle to the first cutting tool (the intensive stirring zone). The total width of the work surface of the cutting tools is 15-30% larger than the length of the zone they are installed in.

### DESCRIPTION

During transportation by a belt conveyor (1) from the metering and mixing plant to the glass furnace service hopper (8) of the glass furnace, the batch glass segregates into layers, cools off and loses a considerable share of moisture.

An additional factor that negatively affects the quality of the mix of batch and scrap glass loaded into a glass furnace is the fact that a vibrating feeder (2) feeds into the batch without stirring, resulting in dry scrap glass which has a lower temperature than the batch temperature. This slows the processes of batch melting and complicates the homogenization of the glass mass.

Moreover, when a batch of glass is sent to a shuttle conveyor (6) and service hoppers (8), heavy dusting of insufficiently wetted glass takes place, which disturbs the chemical composition of the batch.

To eliminate the above shortcomings and stabilize the glass making process, a continuous-action drum mixer with mixing cutting tools and with vertical loading and unloading, is installed between the belt conveyor (1) for batch feeding and the shuttle conveyor (6) for loading batch and scrap glass to the glass furnace loading hoppers (8). This provides additional vetting and homogenization of a batch of glass to the required degree of processing.

This solution makes it possible to conduct a continuous mixing of the flow of batch and scrap glass, insuring a high quality mixture of a batch of scrap glass when loading them to the glass furnace.

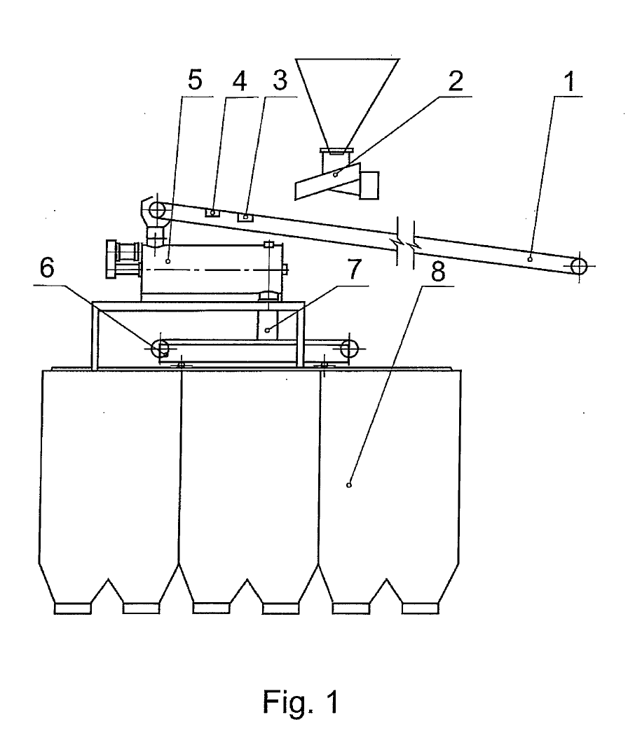

The process of preparation of a batch of scrap glass (FIG. 1) is conducted as follows.

Batch is fed from the metering and mixing plant by the belt conveyor (1). Scrap glass (2) is weighed and fed by the vibrating feeder (1) onto a layer of batch.

The first sensor (3) installed on the belt conveyor (1) signals the presence of batch and turns on the mixer (5). When batch passes the second sensor (4), a signal is received to open the hot water valve (19) or the steam valve (20) to the mixer. Water (steam) comes through a pressure control valve and is injected by an injector into the first (loading) zone of the mixer. The amount of water and steam is controlled according to a preset program. To do this, a strain-gage transducer for batch weighing and a water supply pump controller are installed on the conveyor.

Batch arrives from the conveyor (1) to the mixer (5) over a chute; then, stirred and wetted batch is directed toward the discharge hole and unloaded onto the shuttle conveyor (6) and then into hoppers (8) of the glass furnace doghouse. To catch hardware iron, magnetic separators (7) are installed under the outlet chute of the mixer.

Maintenance of the mixer, which includes visually inspecting mechanical condition of components, checking the wear of scrapers and mixing cutting tools and replacing them, if necessary, and cleaning the mixer from compacted batch, is performed three times a week. The mixer frame is installed on rails, which makes it possible to roll the mixer away to the side during the repair and installation of an overhead chute.

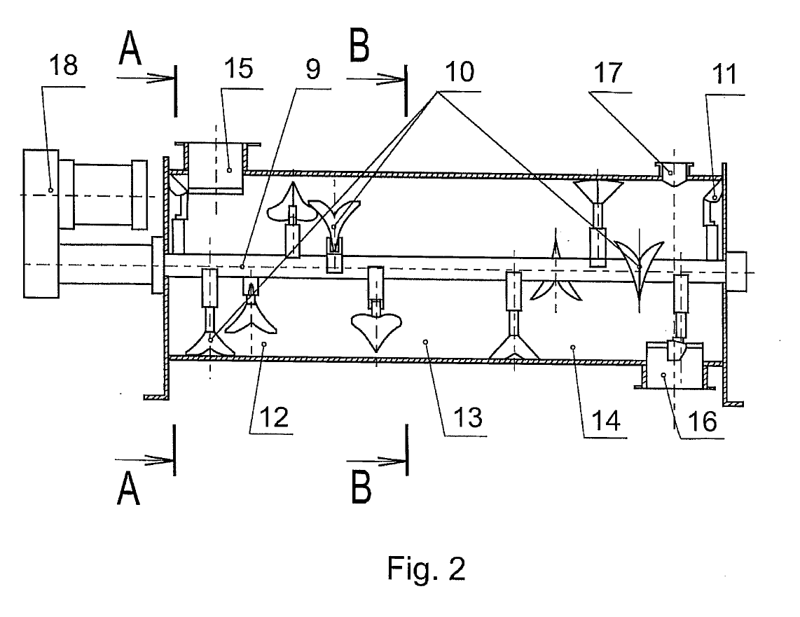

FIG. 2 shows the vertical section of the mixer. A rotor shaft (9) with blades in the form of mixing cutting tools (10) in the front and rear sections of the shaft and with scrapers (11) for cleaning the mixer housing end walls is installed horizontally in the mixer housing. The rotor turns, and the stirred and wetted batch moves toward the discharge hole, and from there, onto a shuttle conveyor. In terms of the number, design and arrangement of the mixing cutting tools on the rotor, the mixer is divided into three zones: the first is the loading zone (12) of intense stirring; the second is the accumulation zone (13) of slow stirring; and the third is the unloading zone (14).

The scrapers have a different design than the mixing cutting tools because they must scrape off batch stuck to the mixer's end walls and feed it under the cutting tools.

The dimensions and the number of scrapers in the mixing chamber are determined based on the required mixer output.

The mixer also has an inlet hole for loading batch and scrap glass (15), an outlet hole (16), and a hole for an aspiration system (17). The mixer has a drive (18).

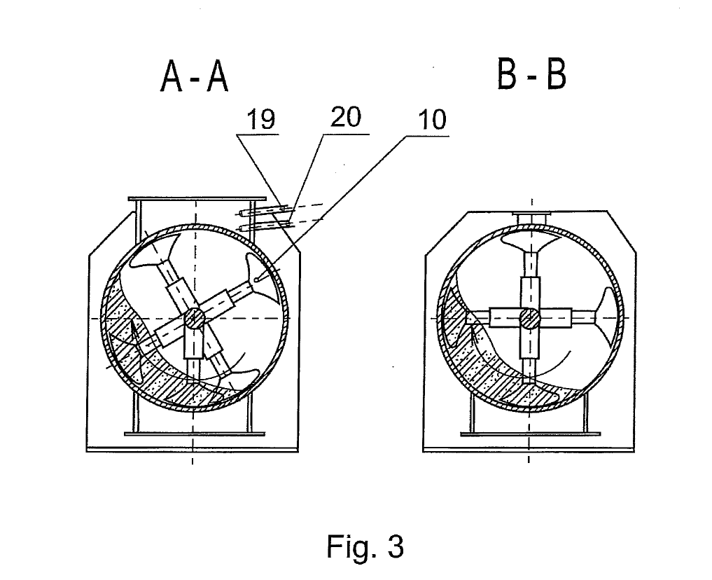

FIG. 3 shows sections A-A and B-B of the mixer. On the shaft of the mixer loading and unloading zones, mixing cutting tools (10) are installed; they are uniformly distributed around the circumference of the shaft at a 90° angle to the shaft, except that the second cutting tool is installed at a 60° angle to the first cutting tool. The mixer has a water nozzle (19) and a steam nozzle (20).

The ratio of the mixer's inside diameter and length is approximately ⅓, taking into account the required output of about 8 tons/hour per 1 m of length of the mixer housing. The distance between the inlet and outlet holes and batch movement in the mixer are selected so as to achieve the maximum homogeneity and the required parameters of humidity and temperature of the mixture of batch and scrap glass.

Mixing cutting tools (10) are installed along the length of the rotor shaft (9) with a certain pitch along the cutting tool axis and at a certain angle between the adjacent cutting tools, with a slight overlap of the zones of each one during rotation. The second, accumulation zone (13) of the mixer does not have mixing cutting tools; the length of this zone is about 7/25 of the total length of the mixer housing. The first, loading zone (12) and the third, unloading zone (14) along the length of the mixer's housing have the same length. In each of these zones, there are equally spaced mixing cutting tools (10) and one scraper (11) on the mixer housing end walls. All of the mixing cutting tools are uniformly distributed around the circumference of the shaft at a 90° angle to the shaft, except that the second cutting tool is installed at a 60° angle to the first cutting tool for intense stirring.

The total work surface (total width) of the mixing cutting tools is 15-30% larger than the length of the zone they are installed in; the overlap is ⅗ of the cutting tool pitch.

The placement of scrapers (11) and mixing cutting tools (10) in the batch loading and unloading zones ensures layered stacking of materials in the mixer which helps to produce a mixture of batch and scrap glass with maximum homogeneity.

Thus, the proposed mixer, which is installed directly above loading hoppers of the glass making furnace (8), makes it possible to eliminate almost all the following shortcomings of current mixers:

additional batch stirring and wetting, and a temperature rise, take place directly above the spot where batch is loaded into the glass furnace;

a lower homogeneity is eliminated, and losses in batch humidity during transportation, pouring and intermediate storage in storage hoppers are compensated for;

batch humidity can be raised before loading it into the furnace at the optimum value (5-7%) without reducing batch homogeneity and without deteriorating the operating conditions of the transportation equipment;

loss of heat can be compensated for during batch transportation and batch temperature can be increased to 35-60° C. before loading it into the furnace;

silicate forming processes in the batch itself can be accelerated by feeding heated batch to the service hopper above the loader that has a temperature over 80° C. due to heat radiation from the glass making furnace;

dusting and carryover of batch components to regenerators can practically be eliminated, thus reducing the rate of corrosion of refractory materials of the superstructure and regenerator brickwork, and increasing the length of time between repairs of the glass making furnace;

glass furnace output can be increased, glass quality can be improved, and heat and power consumption can be improved and reduced due to the realization of the above advantages.

The following are claimed:

1. An intensive mixer for batches of glass, which has a cylindrical mixing chamber, with an inlet fitting (15) for loading the batch and the glass scraps, as well as nozzles (19 and 20) for supplying water and steam, characterized in that
the mixing chamber is divided up into a loading zone (12), an accumulation zone (13) and an unloading zone (14);
a central rotor shaft (9) and an outlet opening (16) for unloading the mixture of the batch and the glass scraps, with magnetic separators (7) mounted under it, are disposed in the mixing chamber;
for cleaning the chamber walls, scoop cutters (10) are provided in the loading zone (12), the accumulation zone (13) and the unloading zone (14), which cutters are mounted with their blades at an angle of 90°, extending uniformly all the way around, on the rotor shaft (9); and
for cleaning the chamber end walls, scrapers (11) that clean these end walls are disposed facing toward the chamber end walls.

2. The intensive mixer as defined by claim 1, characterized in that to improve mixing in the loading zone (12), the accumulation zone (13) and the unloading zone (14), second scoop cutters (10) are associated with first scoop cutters (10), which second scoop cutters are mounted on the rotor shaft (9) at an angle of 60° to the first scoop cutters (10).

3. The intensive mixer as defined by claim 1, characterized in that the entire cutting area (total width) of the scoop cutters (10) exceeds the length of the region in which they are mounted by 15 to 30%.

4. The intensive mixer as defined by claim 2, characterized in that the entire cutting area (total width) of the scoop cutters (10) exceeds the length of the region in which they are mounted by 15 to 30%.

5. The intensive mixer as defined by claim 1, characterized in that the inside diameter and the length of the mixer (5) is in a ratio of approximately 1:3.

6. The intensive mixer as defined by claim 2, characterized in that the inside diameter and the length of the mixer (5) is in a ratio of approximately 1:3.

7. The intensive mixer as defined by claim 3, characterized in that the inside diameter and the length of the mixer (5) is in a ratio of approximately 1:3.

8. The intensive mixer as defined by claim 4, characterized in that the inside diameter and the length of the mixer (5) is in a ratio of approximately 1:3.

9. The intensive mixer as defined by one of claim 1, characterized in that above the outlet opening (16) of the unloading zone (14), the mixing chamber is provided with an opening (17) for an aspiration system.

10. The intensive mixer as defined by one of claims 2, characterized in that above the outlet opening (16) of the unloading zone (14), the mixing chamber is provided with an opening (17) for an aspiration system.

11. The intensive mixer as defined by one of claims 3, characterized in that above the outlet opening (16) of the unloading zone (14), the mixing chamber is provided with an opening (17) for an aspiration system.

12. The intensive mixer as defined by one of claim 4, characterized in that above the outlet opening (16) of the unloading zone (14), the mixing chamber is provided with an opening (17) for an aspiration system.

13. The intensive mixer as defined by one of claim 5, characterized in that above the outlet opening (16) of the unloading zone (14), the mixing chamber is provided with an opening (17) for an aspiration system.

14. The intensive mixer as defined by one of claim 6, characterized in that above the outlet opening (16) of the unloading zone (14), the mixing chamber is provided with an opening (17) for an aspiration system.

15. The intensive mixer as defined by one of claim 7, characterized in that above the outlet opening (16) of the unloading zone (14), the mixing chamber is provided with an opening (17) for an aspiration system.

16. The intensive mixer as defined by one of claim 8, characterized in that above the outlet opening (16) of the unloading zone (14), the mixing chamber is provided with an opening (17) for an aspiration system.
